(19) United States
(12) Patent Application Publication
(10) Pub. No.: US 2015/0278221 A1
(43) Pub. Date: Oct. 1, 2015

(54) CONTACT MANAGER FOR UTILIZING SOCIAL MEDIA INFLUENCE

(71) Applicant: XOMAD LLC, Manhattan Beach, CA (US)

(72) Inventor: ROBERT X. PERRY, III, MANHATTAN BEACH, CA (US)

(73) Assignee: XOMAD LLC, MANHATTAN BEACH, CA (US)

(21) Appl. No.: 14/673,714

(22) Filed: Mar. 30, 2015

Related U.S. Application Data
(60) Provisional application No. 61/972,158, filed on Mar. 28, 2014.

(51) Int. Cl. G06F 17/30; H04L 29/08; H04L 29/06

(52) U.S. Cl. CPC G06F 17/3053; H04L 65/403; H04L 67/02

(57) ABSTRACT

A contact manager for utilizing social media influence includes an influencer engine that receives contacts and corresponding contact parameters, such as demographic parameters and lists of first-tier and second-tier contact, from social media sources, and a set of group creation parameters from a user, and calculates as a function of the contact parameters a contact reach score, a contact engagement score, and a contact quality value. The contact manager also includes a list manager that assigns a contact to a list according to the contact quality value.

### CROSS-REFERENCE TO RELATED APPLICATIONS

This application claims the benefit of and priority to U.S. Provisional Patent Application Ser. No. 61/972,158 filed on Mar. 28, 2014, the contents of which are incorporate herein by reference.

### TECHNICAL FIELD

Embodiments of this disclosure are directed towards social media marketing, and more specifically towards a contact manager for utilizing social media influence.

### BACKGROUND

Social media use has grown dramatically over the last several years. Individual users utilize social media to communicate with groups of friends, family, acquaintances, fans, followers, and business colleagues generally referred to as contacts. Commercial use of social media has also grown rapidly for the purposes of information gathering, as well as commercial marketing and advertising. Social media outlets include many known Internet-based applications designed to connect users with their contacts, such as FACEBOOK, TWITTER, and INSTAGRAM, to name just a few.

Social medial communication may be accomplished using contact manager software, applications, or interfaces native to particular social media applications, or built by third parties. These contact manager applications enable users to organize, filter, and communicate with targeted groups of contacts according to certain filtering criteria. Traditionally, the available filtering criteria for a user's contacts has been limited to demographic parameters and relationship parameters relative to the user. Demographic parameters may include information about the contact such as gender, age, geographical location, and marital status, whereas relationship parameters may include information such as whether the contact is a first-tier contact (e.g., a direct contact) with the user, or a second-tier contact (e.g., a direct contact of a user's direct contact). A user may also define his own favorites, such that the user could use a contact manager to communicate with his favorite first-tier contact male friends. Using contact managers in such ways begins to enable very targeted communications approaches that can be used for effective marketing purposes.

### BRIEF SUMMARY OF EMBODIMENTS

Various embodiments of the disclosed technology are directed towards a contact manager for utilizing social media influence. In one embodiment, a method for generating a social media influencer score includes receiving user defined parameters; receiving social-media defined parameters; storing the user defined and social media defined parameters as stored parameters in a database; filtering, with an influencer module, the stored parameters based on pre-determined criteria; and generating, with the influencer score algorithm, an influencer score.

In another embodiment, a system for generating a social media influencer score includes an influencer module configured to receive user defined parameters; receive social-media defined parameters; filter the user defined parameters and the social-media defined parameters based on pre-determined criteria; and calculate, with an influencer score algorithm, an influencer score based on the user defined parameters and the social-media defined parameters.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a diagram of an example contact manager system architecture consistent with embodiments disclosed herein.

FIG. 2 is a diagram of an example contact manager system for utilizing social media influence, consistent with embodiments disclosed herein.

FIG. 3 is a flow chart illustrating a method for generating an influence dependent contact list, consistent with embodiments disclosed herein.

FIG. 4 is a flow chart illustrating a method for determining a contact engagement score, consistent with embodiments disclosed herein.

FIG. 5 is a flow chart illustrating a method for engaging a contact group, consistent with embodiments disclosed herein.

FIGS. 6A-6E are each example diagrams illustrating a graphical user interface used to implement embodiments disclosed herein.

FIG. 7 illustrates an example computing module that may be used to implement various features of the systems and methods disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of this disclosure are directed towards a contact manager for utilizing social media influence. For example, some embodiments are direct towards a system and method for generating and merging a social media influencer score with real world social scenes. Components of the disclosure include interfacing with databases and networks that include social media driven data to calculate a social media influencer score, and incorporating the social media influencer score with real-life activations within social scenes that catalyze social networks creating conversations and social media trending around a brand message. Embodiments also include functionality for sending alerts; accepting payments; sending, broadcasting, and responding to invitations; and creating and managing door lists for individual events.

As disclosed herein, an example of a method for managing contacts may include receiving, with an influencer engine, a first list of contacts and receiving, for each contact of the first list of contacts, a set of contact parameters from a contact source and a set of group creation parameters. For example, some or all of the contacts in the list of contacts may be social media influencers of varying degrees, and the contact source may be a social media site or a user's own email or contact list. The social media site could be FACEBOOK, TWITTER, INSTAGRAM, YOUTUBE, or any other social media site or application as known in the art. The contact parameters may include a set of contact activity parameters, a set of demographic parameters, and a list of first tier and second tier contacts. For example, the contact activity parameters may include the number and types of posts that a particular contact has made, including likes, comments, retweets, and the like. The list of first-tier contacts may include a specific contacts own direct contacts, and the list of second-tier contacts may include the specific contact's indirect contacts (e.g., contacts of contacts). The example of extending a user's network to second-tier contacts is non-limiting, and one of skill in the art would recognize that it is possible to extend the network to third-tier, fourth-tier contacts, etc.

The method may also include generating, with the influencer engine, a contact reach score as a function of the list of first-tier and second-tier contacts, a contact engagement score, as a function of the contact parameters and a contact activity quality score, and a contact quality value, as a function of the contact engagement score and the contact reach score. The contact quality value, thus, quantifies a particular contact's social media influence. The contact quality value may be stored in a data store.

The method may further include storing in the data store, for each contact in the first list of contacts, a set of corresponding contact parameters and a corresponding contact quality value (e.g., the contact quality value generated for a particular contact). The method may further include storing in a second list of contacts each of contact from the first list of contacts for which the corresponding contact parameters and the corresponding contact quality value match the group creation parameters. For example, some embodiments of the method include assigning to a second list of contacts, with a list manager, each contact that exceeds a threshold contact quality value. Thus a group (e.g., a contact list) may be created according to a desired level of social media influence. The list may then be used to send out communications via one or more media content distribution channels (i.e., through email, TWITTER, FACEBOOK, INSTAGRAM, SMS text, etc.). The list of desired media content distribution channels may be customized for each contact and saved in a database. In some embodiments, the first list of contacts and/or the second list of contacts may be visually and interactively displayed on the interface device (e.g., in a graphical user interface (GUI)).

In some example embodiments, a contact management system may include an influencer server. The influencer server may include a list manager, an influencer engine, and a communications module. The contact management system may also include one or more contact sources and an interface device. The interface device could be a mobile phone, portable data assistant (PDA), handheld computer, tablet computer, laptop computer, desktop, smartwatch, or any other device capable of displaying a user interface, operating software applications, and communicating with the contact sources and influencer server via a computer network (e.g., the Internet). For example, the interface device may include a non-transitory computer readable media programmed with contact manager software. The contact manager software may be programmed to selectably connect, via an Internet connection, to the influencer server and cause the influencer engine to receive a first list of contacts and a corresponding set of contact parameters and calculate a contact reach score, a contact engagement score, as a function of the contact parameters and a contact activity quality score, and a contact quality value, as a function of the contact engagement score and the contact reach score.

In some examples, the influencer engine may include two or more sub-engines. A first sub-engine may calculate the number of social media followers plus a social media engagement number, the social media engagement number being equal to the sum of a constant and one or more pre-determined social media parameters. A second sub-engine may employ a learning process that starts after a threshold level of data is obtained, the learning process including collecting data and modifying the social media engagement number based on actual received data and extrapolating based on a line of best fit (e.g. using standard line fitting technology). This data may include variables for event invites, events attended, exclusiveness of such events, social media following, likeliness to posts (based on events attended and number of posts per event) and engagement (which factors in likes, retweets, favorites, shares, comments, etc.) For both processes, data from each social media (e.g. TWITTER, FACEBOOK, and INSTAGRAM) may be analyzed separately and then added together for a final number. As used herein, events may include events at a physical venue, as well as virtual events, such as events that are hosted on the Internet, formations of online groups, and the like.

The user defined parameters may include contact information, gender, age, location, and other personal or user-known data. The social-media defined parameters may include data from social media outlets such as TWITTER, FACEBOOK, INSTAGRAM, social media followers (including the size of follower groupings as determined by age, gender, location and the followers' own social media followings), social media engagement numbers. Other parameters included in the disclosed algorithm may include total number of connections, likes/comments/shares, “voice” ratios=likes/total friends, simple ranking (posts multiplied by reach), summary of posting information about event promoters, brand alliance, etc.

A system for generating and merging a social media influencer score may be implemented by computer readable media programmed to automate and perform processes disclosed in this application, and operating on various networks (including networks enabled by the Internet), and on various devices, including mobile devices, smart phones, tablets, and personal computers.

In some examples, unique sharing algorithms may be used. Users will be able to share details about a contact with other users. They will be able to specifically set permission levels to share only limited information such as name and contact details. Users will also be able to share lists. The system may intelligently merge contacts and only display contact details to users according configurable access control list parameters.

In some examples, calculations may be performed to deduce a contact's “Voice” as a ratio of the contact's social media influencer score as compared with a reference social media influencer score, to determine how much attention is paid to the contacts by their 2nd degree contacts. In this example, the reference social media influencer score may be a pre-determined constant, a maximum social media influencer score across a set of users, an average social media influencer score across a set of users, or a sum of social media influencer scores across a set of users.

In one example, a doorlist module dynamically updates search results such that, as a user enters or modifies search criteria, search results are updated in real time. In this example, as someone RSVP's or checks in at the door, all devices with the list will show the updates in real time. Additional example options include customized alerts indicating when VIP's check-in. Check-in alerts may be sent out to owner/define users. In some examples, users may be given the option to set cut off times for RSVPs and/or make payments with RSVPs. All options may be viewable based on configurable access control list parameters.

In other examples, customized social media “blasts” may be transmitted. Each blast may be defined separately based on criteria set by the list owner, such as social media influence, age range, location, and defined lists created by the list owner. Requests can be made by any recipient of the blast/communication/invite. The list owner will be the acceptor for requests, but the list owner may authorize other users through the permission settings to accept or deny requests.

Also, when users are blasting, they may be able to select the order of priority of the communication medium used to contact those on lists. They may also be able to enable or disable each medium. They may also be able to input the number of mediums over which to contact those on lists. An example of these features is shown on the illustration below of one example screen of a graphical user interface (GUI) designed to control blasting criteria.

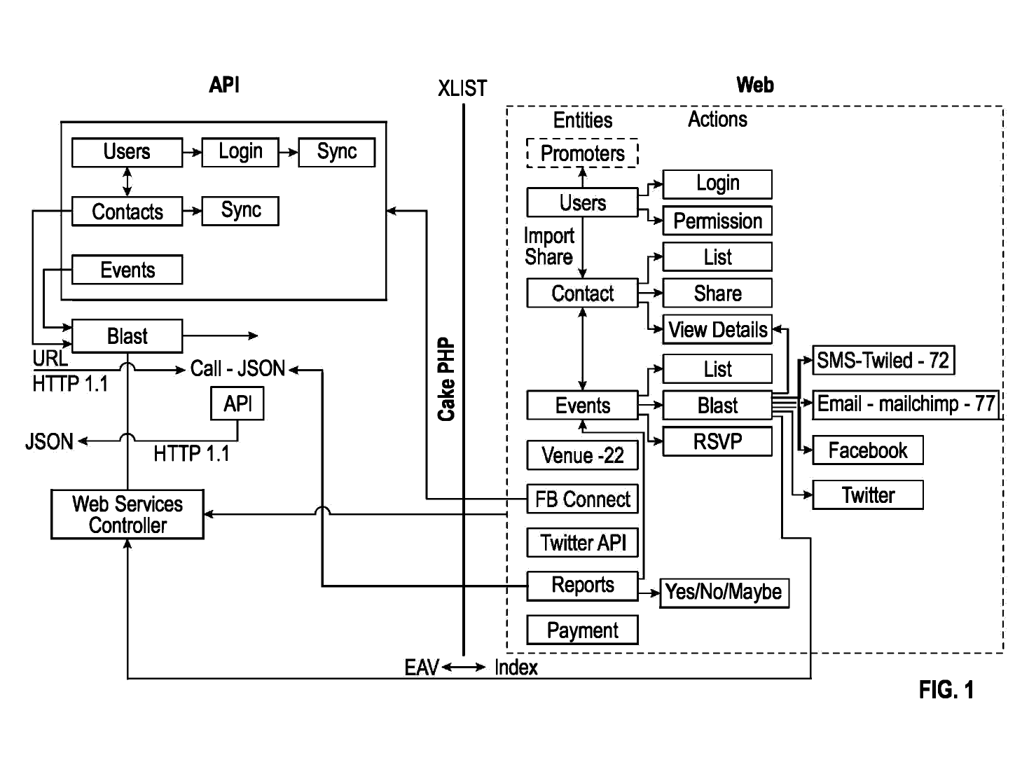

FIG. 1 is a diagram of an example system architecture designed to implement several of the methods disclosed herein. The architecture includes an API module and a Web module. The API module includes an Users sub-module, a Contacts sub-module, an Events sub-module, and a Blast module. The Web module includes a Promoters sub-module, an Users sub-module, a Contacts sub-module, and an Events sub-module. The Web module and API module may interface, for example, using a Cake PHP interface. Alternatively, other Internet enabled communications protocols may be employed.

The aforementioned modules and sub-modules may also communicate with a Database module using standard database querying and insertion protocols as known in the art. The Users sub-modules include mechanisms enabling unique users to securely login to the application, communicate with the Database, and sync data between a local user interface and the database.

The Contacts sub-modules allow display, filtering, editing, modifying, and adding of contacts specific to a unique user. The Contacts module may also communicate with social media data from sources such as FACEBOOK, TWITTER, INSTAGRAM, or other social media tools. The Contacts sub-module may also communicate with a user's local contact's lists from email programs, or mobile device address books. The Contact sub-modules may then display a filtered contacts lists and calculate social media influencer scores for some or all of the contacts listed in that list using embodiments of the method for generating a social media influencer score disclosed herein. Accordingly, the Contacts sub-modules may interface with one or more social media data sources to receive and store social media determined parameters relevant to the social media influencer score calculation as disclosed herein. The Contacts sub-module may also enable a user to share specific contacts or contacts lists with other users.

A Web Services Controller module may be used to enable interfacing between the other modules disclosed herein and the social media data feeds using Internet enabled interfacing technology known in the art.

The Events sub-modules may enable a unique user to list, filter, edit, modify, or add events or lists of events, and then invite user-determined contacts to those events, and allow those contacts to RSVP. The Events sub-modules may also interface with social media data feeds from social media systems disclosed herein, including the ability to display and modify events created via one or more social media applications, or to transmit events data for events created by the Events sub-module to one or more social media applications.

The Blast sub-module interfaces with the Events and Contacts sub-modules to enable a user to send targeted information regarding specified events to predetermined lists of contacts. These contacts lists may be generated through individual user selection, or through filtering algorithms that consider, for example, a social media influencer score.

In some embodiments, the system also includes a Social Media

Influencer Score calculation module. The Social Media Influencer Score calculation module receives parameters from a user (for example, through the Web module), receives parameters from social media data feeds (for example, through the Web Services Controller module), stores the received parameters in a Database, and calculates a social media influencer score for a particular contact according to an influencer score algorithm as disclosed herein.

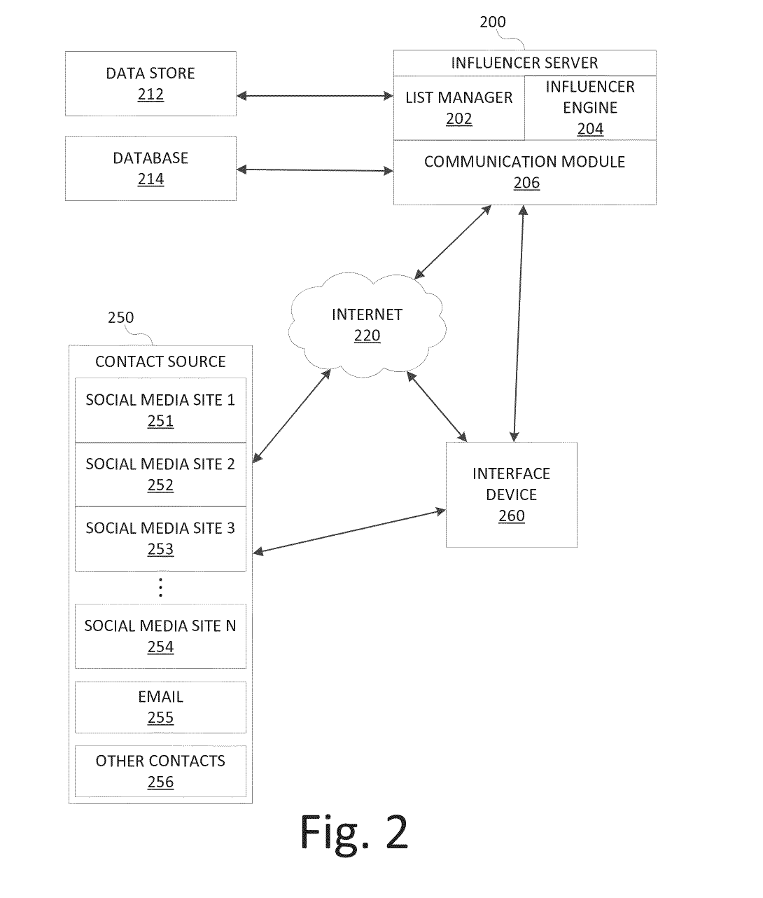

FIG. 2 is a diagram of an example contact manager system for utilizing social media influence, consistent with embodiments disclosed herein. As illustrated, a contact manager system may include influencer server 200, interface device 260, data store 212, and database 214, each configured to communicate via computer network protocols via the Internet, 220. For example, computer network protocols may include TCP/IP, HTTP, SSL, FTP, SMTP, Wi-Fi, GSM, UMTS, LTE, or other computer-based and/or wireless communication protocols as known in the art.

Influencer server 200 may further include list manager 202, influencer engine 204, and communications module 206. For example, list manager 202 may build and manage lists of contacts according to predetermined and/or calculated filter values. Lists may be dynamically updated, or stored for later use in data store 212 and/or database 214. Communications module 206 may communicate with a computer network using the protocols referenced above. Influencer engine 204 may calculate social media influencer values for individual or groups of contacts according to embodiments disclosed herein. For example, influencer engine 204 may receive contact parameters from user input, for example through interface device 260, as well as directly from contact sources 250. As illustrated, contact sources 250 may include one or more social media sites 251 through 254 (e.g., FACEBOOK, INSTAGRAM, TWITTER, YOUTUBE, etc.), as well as a user's email 255, or other contact sources as known in the art.

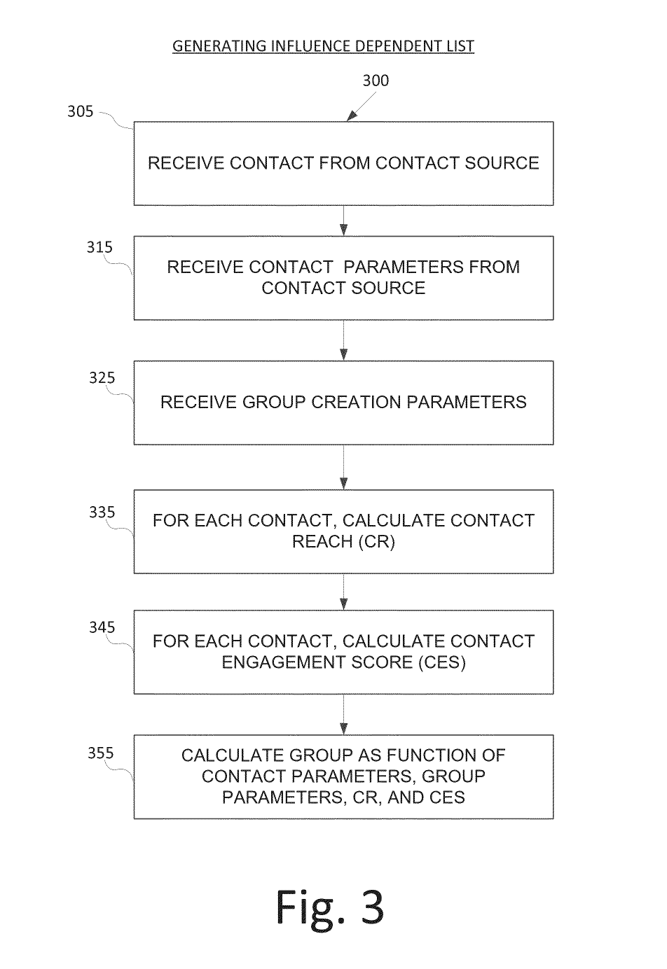

FIG. 3 is a flow chart illustrating a method for generating an influence dependent contact list. As illustrated, a method for generating an influence dependent contact list may include receiving one or more contacts from one or more contact sources at step 305. The contact sources may be the contact sources 250 as described with respect to FIG. 2 above. The contacts may be any of a user's social media, email, or other contacts as managed within any of the contact sources. The method may also include receiving contact parameters from the contact source at step 315. For example, the contact parameters may include a set of contact activity parameters, a set of demographic parameters, and a list of first tier and second tier contacts. For example, the contact activity parameters may include the number and types of posts that a particular contact has made, including likes, comments, retweets, and the like. The list of first-tier contacts may include a specific contact's own direct contacts, and the list of second-tier contacts may include the specific contact's indirect contacts (e.g., contacts of contacts).

The method may also include receiving group creation parameters at step 325. For example, the group creation parameters may be user-defined filter conditions, such as desired demographic parameters, contact engagement values, or other filter parameters. The method may also include generating a contact reach (CR) score for each contact at step 335 and generating a contact engagement score (CES) for each contact at step 345. The method may also include generating a group as a function of contact parameters, group parameters, CR, and CES. The group may then be used by the list manager to upload targeted content.

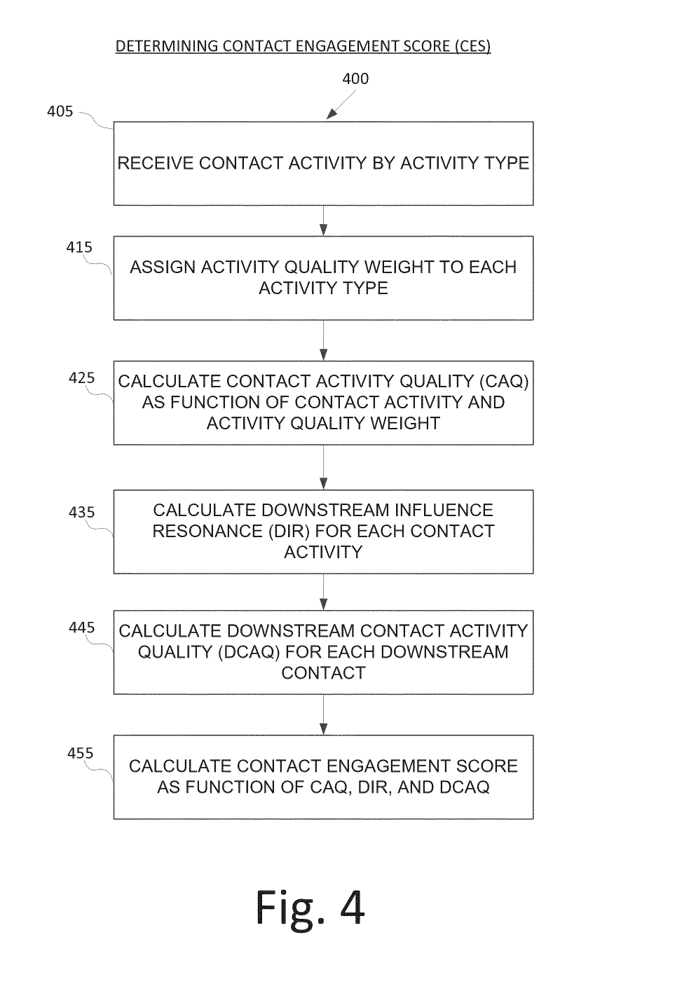

FIG. 4 is a flow chart illustrating a method for determining a contact engagement score. As illustrated, a method for determining CES may include receiving a contacts activity by activity type at step 405. For example, a contact may post blog articles, post comments in a social media site, post original content, like other people's content, follow other contacts, or have accumulated followers. Each of these actions, or any other action, may be compiled in a historical log. Each type of activity may be assigned an activity quality at step 415. The method may further include generating (with the influencer engine, for example) a contact activity quality as a function of the contact activity, weighted by the activity specific weight at step 425. Accordingly, a score may be assigned to a contact's total history of activity quantifying the quality of those activities. In some examples, more weight may be given to more recent activities.

In some examples, the method may also include generating a downstream influence resonance (DIR) for each contact. The DIR may include the amount of activity a user's second-tier contacts focus on the activities of the user's first-tier contacts, such as re-posting, re-tweeting, following, liking, or other second-tier activities. At step 445, these downstream activities may also be weighted based on activity quality to generate a downstream contact activity quality score (DCAQ). The DCAQ may also incorporate desired demographic parameters belonging to the second-tier contacts that may contribute to or detract from the overall influencer quality, and thus, amplify or attenuate the DCAQ accordingly. The CES may then be calculated by the influencer engine as a function of one or more of the CAQ, DIR, and DCAQ values. The CES may then be used by the list manager as a filter criteria to generate static or dynamic lists.

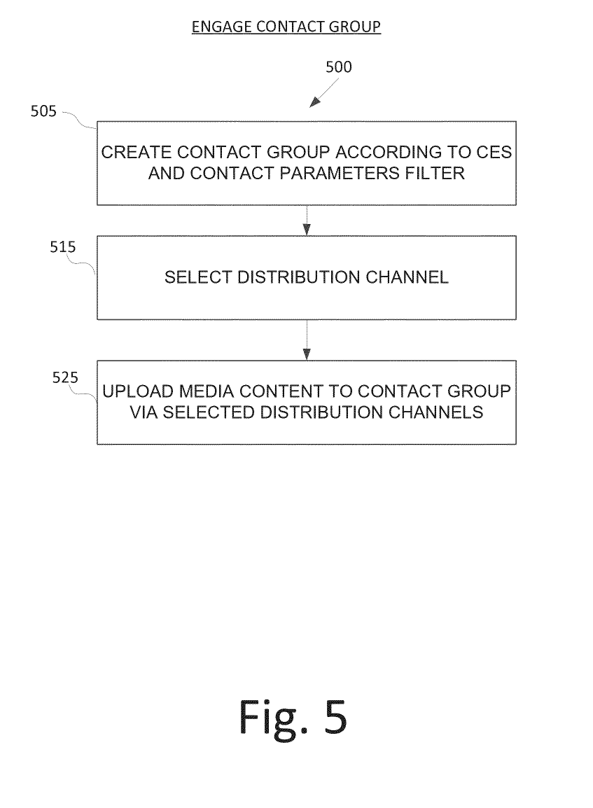

FIG. 5 is a flow chart illustrating a method for engaging a contact group. As illustrated, a method for engaging a contact group (e.g., a list of contacts) may include creating the contact group according to contact parameters and CES parameters at step 505. The method may also include selecting distribution channels at step 515. For example, the distribution channel may be one or more social media sites, email, text, or other communication outlet as known in the art. The method may also include uploading media content to the contact group via selected distribution channels at step 525. For example, the user may setup a blast communication to a group of highly influential male contacts in a specific geographical region via predetermined, contact-specific distribution channels.

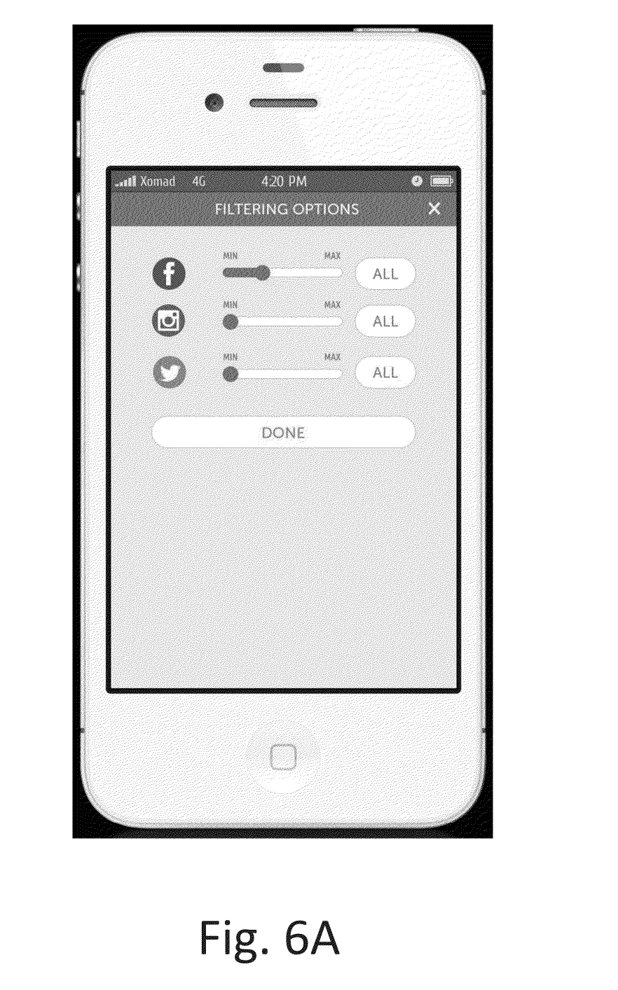

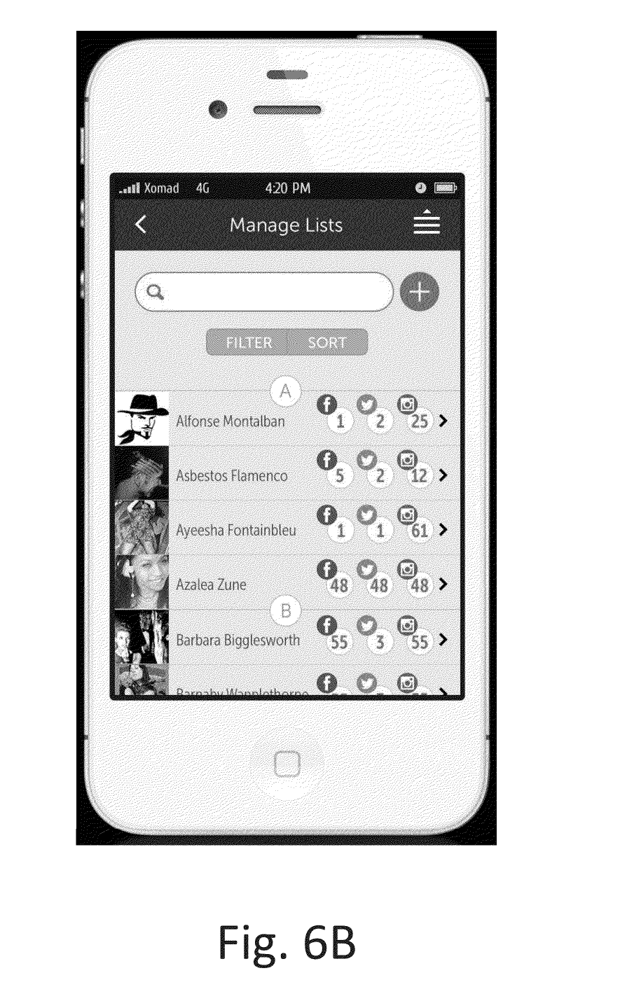

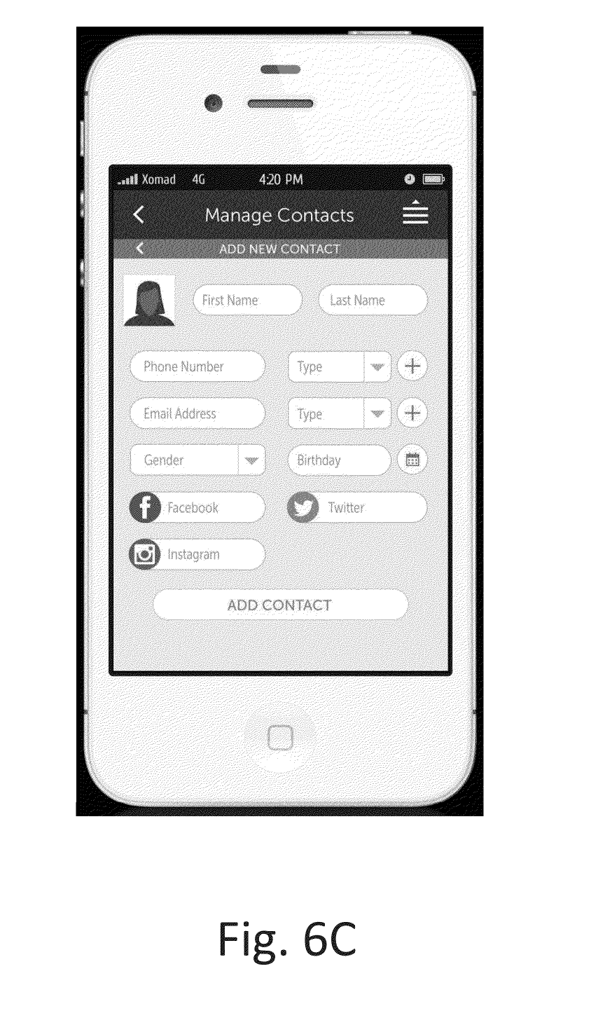

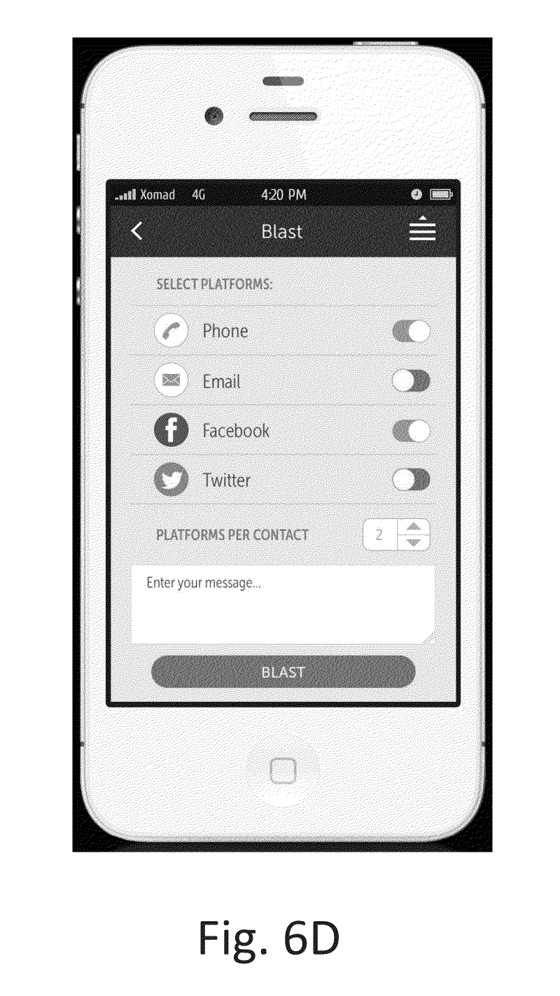

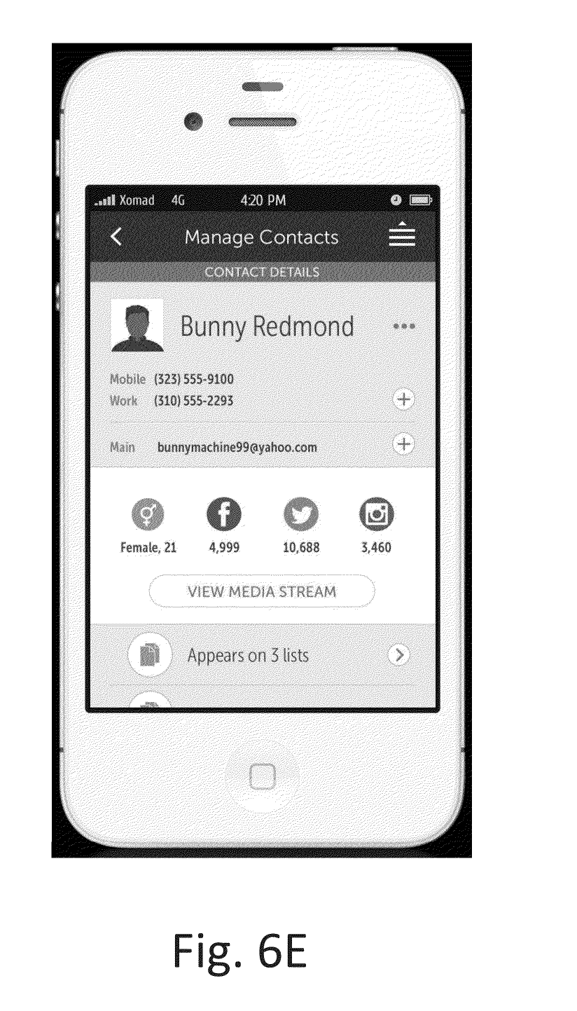

FIGS. 6A-6E are each example diagrams illustrating a graphical user interface used to implement embodiments disclosed herein.

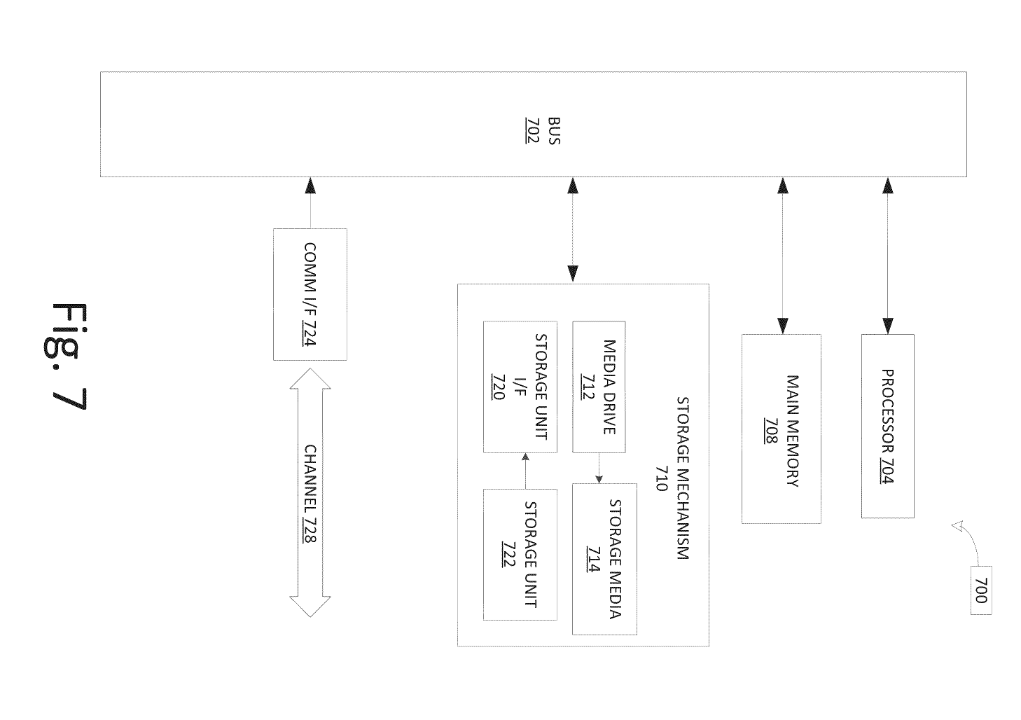

FIG. 7 illustrates an example computing module that may be used to implement various features of the systems and methods disclosed herein. In one embodiment, the computing module includes a processor and a set of computer programs residing on the processor. The set of computer programs may be stored on a non-transitory computer readable medium having computer executable program code embodied thereon. The computer executable code may enable and operate each of the modules and sub-modules disclosed herein. The computer executable code may further be configured to receive input from users, databases, and social media services and to calculate a Social Media Influencer Score. The computer executable code may further be configured to display a graphical user interface, and to further display the Social Media Influencer Score within the graphical user interface.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.?

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 1500 or to communicate externally.

Computing module 700 might also include one or more memory modules, simply referred to herein as main memory 708. For example, preferably random access memory (RAM) or other dynamic memory, might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid state drive, a magnetic tape drive, an optical disk drive, a CD or DVD drive (R or RW), or other removable or fixed media drive might be provided. Accordingly, storage media 714 might include, for example, a hard disk, a solid state drive, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing module 700. Such instrumentalities might include, for example, a fixed or removable storage unit 722 and a storage interface 720. Examples of such storage units 722 and storage interfaces 720 can include a program cartridge and cartridge interface, a removable memory (for example, a flash memory or other removable memory module) and memory slot, a PCMCIA slot and card, and other fixed or removable storage units 722 and storage interfaces 720 that allow software and data to be transferred from the storage unit 722 to computing module 1500.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 708, storage unit 720, media 714, and channel 728. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 700 to perform features or functions of the present application as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for assembling and leveraging high quality influencers from a list of contacts comprising:
receiving, with a influencer engine, a first list of contacts and storing the first list of contacts in a data store;
receiving, for each contact of the first list of contacts, a set of contact parameters from a contact source and a set of group creation parameters from an interface device, wherein the contact parameters comprise a set of contact activity parameters and a list of first tier and second tier contacts;
generating, with the influencer engine:
a contact reach score, as a function of the list of first-tier and second-tier contacts;
a contact engagement score, as a function of the contact parameters and a contact activity quality score; and
a contact quality value, as a function of the contact reach score and the contact engagement score;
storing in the data store, for each contact in the first list of contacts, a set of corresponding contact parameters and a corresponding contact quality value; and
storing in a second list of contacts each of contact from the first list of contacts for which the corresponding contact parameters and the corresponding contact quality value match the group creation parameters.

2. The method of claim 1, further comprising receiving, for each contact, a list of desired media content distribution channels.

3. The method of claim 2, further comprising displaying on the interface device an interactive visual representation of the second list of contacts, and uploading a media content data set, with a communications module, to each contact of the second list of contacts via each of the desired media content distribution channels.

4. The method of claim 1, wherein the contact parameters further comprise one or more demographic parameters, and the set of contact activity parameters comprise a list of first-tier historical social media interactions performed by the contact.

5. The method of claim 4, wherein the generating the contact activity quality score comprises assigning an activity quality weight to each first-tier historical social media interaction, such that the contact activity quality score is a function of the number of first-tier historical social media interactions performed by the contact and the corresponding activity quality weight for each first-tier historical social media interaction.

6. The method of claim 5, wherein the generating the contact activity quality score further comprises receiving a list of second-tier historical social media interactions performed by each second-tier contact, and generating a downstream influence resonance score as a function of the ratio of first-tier historical social media interactions to second-tier historical social media interactions.

7. The method of claim 6, wherein the generating the contact activity quality score further comprises assigning a downstream contact activity quality score as a function of each second-tier historical social media interaction and each corresponding activity quality weight.

8. The method of claim 1, wherein the list of contacts comprises FACEBOOK contacts, TWITTER contacts, INSTAGRAM contacts, or email contacts.

9. The method of claim 1, wherein the demographic parameters comprise age, gender, geographical location, or marital status.

10. The method of claim 1, wherein the interface device comprises a mobile phone, a smart watch, a handheld computer, a portable data assistant (PDA), a tablet computer, a laptop computer, or a desktop computer.

11. The method of claim 3, wherein the uploading the media content data set further comprises retrieving and dynamically updating the second list of contacts by regenerating the contact engagement score.

12. A system for managing high quality influencers from a list of contacts comprising:
an influencer server comprising a list manager, an influencer engine, and a communications module;
one or more contact sources;
and an interface device comprising non-transitory computer readable media with contact manager software programmed thereon, the contact manager software programmed to selectably connect, via an Internet connection, to the influencer server and cause the influencer engine to:
receive a first list of contacts, a corresponding set of contact parameters, and a set of group creation parameters; and
generate a contact reach score, a contact engagement score, and a contact activity quality score; and
generate and store in a data store a contact quality value as a function of the contact engagement score the contact reach score, and the contact activity quality score.

13. The system of claim 12, wherein the contact manager software is further programmed to selectably connect, via an Internet connection, to the list manager to cause the list manager to compile and store in a data store a second list of contacts filtered from the first list of contacts according to the set of group creation parameters, contact parameters, and contact quality value score.

14. The system of claim 12, wherein the interface device comprises a mobile phone, a smart watch, a handheld computer, a portable data assistant (PDA), a tablet computer, a laptop computer, or a desktop computer.

15. The system of claim 12, wherein the one or more contact sources comprise FACEBOOK, TWITTER, INSTAGRAM, or email.

16. The system of claim 13, wherein the contact manager software is further programmed to cause the list manager to receive, for each contact, a list of desired media content distribution channels.

17. The system of claim 16, wherein the contact manager software is further programmed to selectably cause the communications module to upload a media content data set to each contact of the second list of contacts via each of the desired media content distribution channels.

18. The system of claim 12, wherein the set of contact parameters comprises a list of first-tier historical social media interactions performed by the contact and the contact manager software is further programmed to cause the influencer engine to calculate the contact activity quality score as a function of a number of first-tier historical social media interactions performed by the contact and a corresponding activity quality weight for each first-tier historical social media interaction.

19. The system of claim 18, wherein the contact manager software is further programmed to cause the influencer engine to calculate the contact activity quality score as a function of a downstream influence resonance score, wherein the downstream influence resonance score is a function of the ratio of first-tier historical social media interactions to second-tier historical social media interactions.

20. The system of claim 12, wherein the contact parameters comprise demographic parameters, wherein the demographic parameters comprise age, gender, geographical location, or marital status.
